(19) United States
(12) Patent Application Publication
(10) Pub. No.: US 2022/0122635 A1
(43) Pub. Date: Apr. 21, 2022

(54) PERPENDICULAR MAGNETIC RECORDING MEDIUM

(71) Applicants: TANAKA KIKINZOKU KOGYO K.K., Tokyo (JP); TOHOKU UNIVERSITY, Sendai-shi, Miyagi (JP)

(72) Inventors: Kim Kong THAM, Tsukuba-shi (JP); Tomonari KAMADA, Tsukuba-shi (JP); Ryousuke KUSHIBIKI, Tsukuba-shi (JP); Shin SAITO, Sendai-shi (JP)

(73) Assignees: TANAKA KIKINZOKU KOGYO K.K., Tokyo (JP); TOHOKU UNIVERSITY, Sendai-shi, Miyagi (JP)

(21) Appl. No.: 17/422,369

(22) PCT Filed: Dec. 23, 2019
(86) PCT No.: PCT/JP2019/050388

§ 371 Date: Jul. 12, 2021

(30) Foreign Application Priority Data
Jan. 11, 2019 (JP) 2019-003874

(51) Int. Cl. G11B 5/66; G11B 5/73

(52) U.S. Cl. CPC G11B 5/66; G11B 5/7369

(57) ABSTRACT

Provided is a perpendicular magnetic recording medium that exhibits improved thermal stability and achieves reduction in switching magnetic field by providing a cap layer having characteristics (characteristics contributing to reducing switching magnetic field of the perpendicular magnetic recording medium as well as to improving thermal stability thereof) superior to existing cap layers.

A perpendicular magnetic recording layer (24) has a granular structure which comprises Co- Pt-alloy magnetic crystal grains (24A) and a non-magnetic grain boundary oxide (24B). A cap layer (26) has a granular structure which comprises Co-Pt-alloy magnetic crystal grains (26A) and a magnetic grain boundary oxide (26B). The Co- Pt -alloy magnetic crystal grains (26A) in the cap layer (26) contain 65-90 at % of Co and 10-35 at % of Pt. The magnetic grain boundary oxide (26B) is included in a volume fraction of 5-40 vol % with respect to the total volume of the cap layer (26).

### TECHNICAL FIELD

The present invention relates to a perpendicular magnetic recording medium, and in detail, to a perpendicular magnetic recording medium having a perpendicular magnetic recording layer and a cap layer covering the perpendicular magnetic recording layer. In this application, the cap layer is a layer covering the perpendicular magnetic recording layer in a perpendicular magnetic recording medium and adjusting the degree of intergranular exchange coupling between the magnetic crystal grains of the perpendicular magnetic recording layer.

### BACKGROUND ART

The perpendicular magnetic recording layer of a current perpendicular magnetic recording medium is a granular layer, and a non-magnetic grain boundary oxide is used to magnetically separate each magnetic grain from adjacent magnetic grains (see, for example, Patent Literature 1).

In this current perpendicular magnetic recording medium at tempts are being made to achieve even higher recording densities, but are faced with the problem of trilemma. The problem of trilemma is to improve all three characteristics: signal-to-noise ratio (SNR), thermal stability, and ease of magnetic recording. In order to overcome the problem of trilemma by improving all three properties, it is necessary that the intergranular exchange coupling between the magnetic grains in the perpendicular recording layer, which is a granular layer, is adjusted appropriately to improve the thermal stability of the perpendicular recording layer and to reduce the switching magnetic field (the magnetic field necessary for magnetization reversal of the magnetic grains).

Therefore, in a current perpendicular magnetic recording medium, a cap layer is provided on top of the perpendicular magnetic recording layer that is a granular layer. The current cap layer is, for example, a CoPt alloy such as CoPtCrB (see, for example, Patent Literatures 2 and 3).

However, in order to overcome the of aforementioned problem of trilemma, it is required to develop a cap layer with better characteristics than the current cap layer to improve the thermal stability of the perpendicular magnetic recording medium and to reduce the switching magnetic field.

### CITATION LIST

### Patent Literature

Patent Literature 1: Japanese Patent Application Laid-Open Publication No. 2000-306228
Patent Literature 2: Japanese Patent Application Laid-Open Publication No. 2009-59402
Patent Literature 3: Japanese Patent Application Laid-Open Publication No. 2011-34665

### SUMMARY OF INVENTION

### Technical Problem

The present invention has been made in view of such points, and it is an object of the present invention to provide a perpendicular magnetic recording medium that achieves improved thermal stability and reduction in switching magnetic field by equipping it with a cap layer having characteristics (characteristics contributing to reducing switching magnetic field of the perpendicular magnetic recording medium as well as to improving thermal stability thereof) superior to current cap layers.

### Solution to Problem

The present inventors observed the cap layer of the current perpendicular magnetic recording media using a transmission electron microscope (hereinafter referred to as “TEM”), and found that the current cap layer has concavity and convexity in the boundary surface with the perpendicular magnetic recording layer, and voids are formed above the non-magnetic grain boundary oxide of the perpendicular magnetic recording layer, resulting in non-uniformity in thickness direction of the current cap layer. The present inventors considered that, since the current cap layer consists of a metal alloy layer (for example, CoPt alloys such as CoPtCrB), the current cap layer is difficult to wet with the non-magnetic grain boundary oxide in the magnetic recording layer (granular layer), so that non-uniformity in thickness direction of the current cap layer results. Therefore, the present inventors conducted research and development of a cap layer by using a material that becomes a granular structure similar to that of the perpendicular magnetic recording layer, and have arrived at the present invention that solves the aforementioned problem.

That is, a first aspect of a perpendicular magnetic recording medium according to the present invention is a perpendicular magnetic recording medium comprising a perpendicular magnetic recording layer and a cap layer covering the perpendicular magnetic recording layer, wherein the perpendicular magnetic recording layer contains a granular structure having CoPt alloy magnetic crystal grains and a non-magnetic grain boundary oxide; the cap layer contains a granular structure having CoPt alloy magnetic crystal grains and a magnetic grain boundary oxide; the CoPt alloy magnetic crystal grains in the cap layer contain Co in a range of 65 at % or more and 90 at % or less and Pt in a range of 10 at % or more and 35 at % or less; and the volume fraction of the magnetic grain boundary oxide to the entire cap layer is 5 vol % or more and 40 vol % or less.

A second aspect of a perpendicular magnetic recording medium according to the present invention is a perpendicular magnetic recording medium comprising a perpendicular magnetic recording layer and a cap layer covering the perpendicular magnetic recording layer, wherein the perpendicular magnetic recording layer contains a granular structure having CoPt alloy magnetic crystal grains and a non-magnetic grain boundary oxide; the cap layer contains a granular structure having CoPt alloy magnetic crystal grains and a magnetic grain boundary oxide; the CoPt alloy magnetic crystal grains in the cap layer contain Co in a range of 70 at % or more and less than 85 at %, Pt in a range of 10 at % or more and 20 at % or less, and at least one element selected from the group consisting of Cr, Ti, B, Mb, Ta, Nb, W and Ru in a range of 0.5 at % or more and 15 at % or less; and the volume fraction of the magnetic grain boundary oxide to the entire cap layer is 5 vol % or more and 40 vol % or less.

A rare earth oxide may be used as the magnetic grain boundary oxide.

The magnetic grain boundary oxide is, for example, at least one oxide of a Gd oxide, a Nd oxide, a Sm oxide, a Ce oxide, an Eu oxide, a La oxide, a Pr oxide, a Ho oxide, an Er oxide, a Yb oxide, and a Tb oxide.

### Advantageous Effects of Invention

According to the present invention, it is possible to provide a perpendicular magnetic recording medium that achieves improved thermal stability and reduction in switching magnetic field by equipping it with a cap layer having characteristics (characteristics contributing to reducing switching magnetic field of the perpendicular magnetic recording medium as well as to improving thermal stability thereof) superior to current cap layers.

### BRIEF DESCRIPTION OF DRAWINGS

FIG. 1 is a cross-sectional schematic diagram illustrating a perpendicular magnetic recording medium 10 according to an embodiment of the present invention.

FIG. 2 is a vertical cross-sectional diagram schematically illustrating a portion of a vertical cross section of the perpendicular magnetic recording medium 10 according to the present embodiment.

FIG. 3 is a vertical cross-sectional diagram schematically illustrating a portion of a vertical cross section of the perpendicular magnetic recording medium 10 (after optimizing the cap layer 26) according to the present embodiment.

FIG. 4 is a vertical cross-sectional diagram schematically illustrating a portion of a vertical cross section of a current perpendicular magnetic recording medium 100.

FIG. 5 is a cross-sectional TEM photograph of a region containing a cap layer (Co₈₀Pt₂₀- 30 vol % Gd₂O₃) (deposited at an argon gas pressure of 0.6 Pa) with a thickness of 9 nm in Example 17.

FIG. 6 is a cross-sectional TEM photograph of a region containing a cap layer (Co₈₀Pt₂₀- 30 vol % Gd₂O₃) (deposited at an argon gas pressure of 4.0 Pa) with a thickness of 9 nm in Example 8.

FIG. 7 is a cross-sectional TEM photograph of a region containing a cap layer (CoPtCrB) in a current perpendicular magnetic recording medium (Comparative Example 20).

FIG. 8 is a dark field image of a portion of the cross-sectional region of Example 17 shown in FIG. 5, taken by a scanning transmission electron microscope (STEM).

FIG. 9 is photographs showing the measurement results of energy dispersive X-ray analysis (EDX) performed by a scanning transmission electron microscope (STEM) for a portion of the cross-sectional region of Example 17 shown in FIG. 5, where (a) shows the distribution results of Gd, (b) shows the distribution results of O (oxygen), (c) shows the distribution results of Co, and (d) shows the distribution results of Pt.

FIG. 10 is a dark field image of a portion of the cross-sectional region of Example 8 shown in FIG. 6, taken by a scanning transmission electron microscope (STEM).

FIG. 11 is photographs showing the measurement results of energy dispersive X-ray analysis (EDX) performed by a scanning transmission electron microscope (STEM) for a portion of the cross-sectional region of Example 8 shown in FIG. 6, where (a) shows the distribution results of Gd, (b) shows the distribution results of O (oxygen), (c) shows the distribution results of Co, and (d) shows the distribution results of Pt.

FIG. 12 is dark-field images of a portion of the cross-sectional region of the current perpendicular magnetic recording media (comparative example 20) shown in FIG. 7, taken by a scanning transmission electron microscope (STEM).

FIG. 13 is photographs showing the measurement results of energy dispersive X-ray analysis (EDX) performed by a scanning transmission electron microscope (STEM) for a portion of the cross-sectional region of the current perpendicular magnetic recording medium (comparative example 20) shown in FIG. 7, where (a) shows the distribution results of Cr, (b) shows the distribution results of O (oxygen), (c) shows the distribution results of Co, and (d) shows the distribution results of Pt.

FIG. 14 is a planar TEM photograph of the horizontal cross section of the region containing a cap layer (Co₈₀Pt₂₀- 30 vol % Gd₂O₃) of Example 143.

FIG. 15 is a planar TEM photograph of the horizontal cross section of the region containing a cap layer (Co₈₀Pt₂₀- 30 vol % Nd₂O₃) of Example 144.

FIG. 16 is a planar TEM photograph of the horizontal cross section of the region containing a cap layer (Co₈₀Pt₂₀- 30 vol % Sm₂O₃) of Example 145.

### DESCRIPTION OF EMBODIMENTS

Embodiments of the present invention will be described below with reference to the drawings.

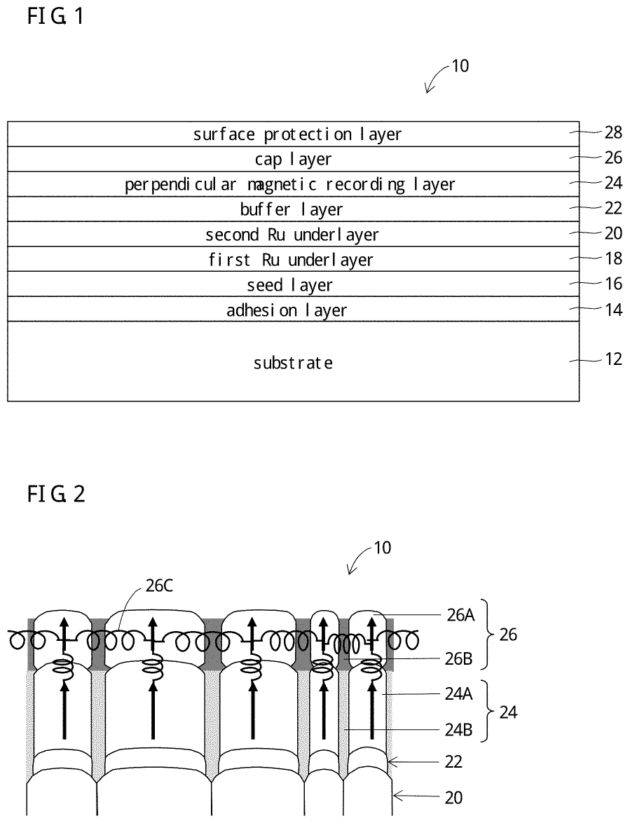

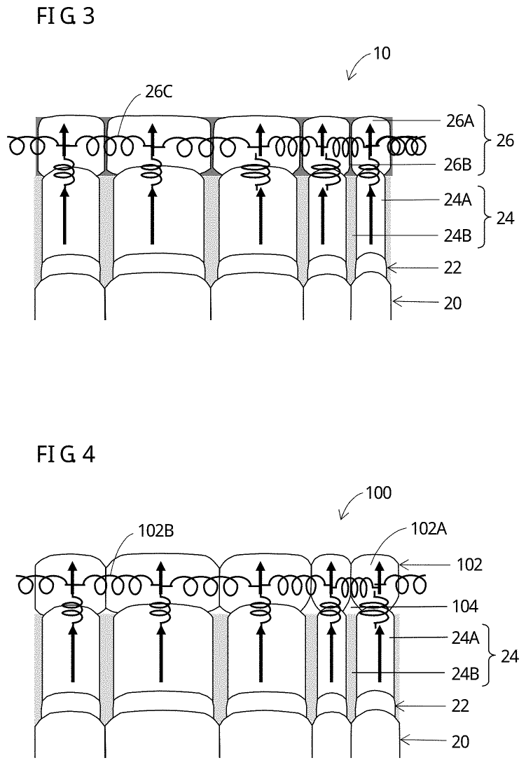

FIG. 1 is a cross-sectional schematic diagram illustrating a perpendicular magnetic recording medium 10 according to an embodiment of the present invention. FIG. 2 is a vertical cross-sectional diagram schematically illustrating a portion of a vertical cross section of the perpendicular magnetic recording medium 10 according to the present embodiment, and FIG. 3 is a vertical cross-sectional diagram schematically illustrating a portion of a vertical cross section of the perpendicular magnetic recording medium 10 (after optimizing the cap layer 26) according to the present embodiment.

### (1) Structure of the Perpendicular Magnetic Recording Medium 10

The perpendicular magnetic recording medium 10 according to the present embodiment has a structure in which an adhesion layer 14, a seed layer 16, a first Ru underlayer 18, a second Ru underlayer 20, a buffer layer 22, a perpendicular magnetic recording layer 24, a cap layer 26, and a surface protection layer 28 are formed in sequence on a substrate 12.

As the substrate 12, various known substrates used for perpendicular magnetic recording media can be used, and for example, a glass substrate can be used.

The adhesion layer 14 is a layer for enhancing adhesion between the seed layer 16, which is a metallic film and the substrate 12. For example, a Ta layer or the like can be used as the adhesion layer 14.

The seed layer 16 is a layer for controlling the crystal orientation and crystal growth of the first Ru underlayer 18, and for example, a Ni₉₀W₁₀ layer or the like can be used as the seed layer 16.

The first Ru underlayer 18 is a layer for suitably controlling the crystal orientation, grain size, and grain boundary segregation of the perpendicular magnetic recording layer 24. The first Ru underlayer 18 is a hexagonal close-packed (hcp) structure. The thickness of the first Ru underlayer 18 is, for example, about 10 nm.

The second Ru underlayer 20 is a layer to provide an uneven shape on the surface (i.e., the surface of the second Ru underlayer 20) of the two-layer Ru underlayer (the first Ru underlayer 18 and the second Ru underlayer 20) so that the buffer layer 22 has a desirable layer structure. The thickness of the second Ru underlayer 20 is, for example, about 10 nm. When a Ru₅₀Co₂₅Cr₂₅- 30 vol % TiO₂ layer is provided as a buffer layer 22 on top of the second Ru underlayer 20, Ru₅₀Co₂₅Cr₂₅ is formed in the convex part of the second Ru underlayer 20 and TiO₂ is formed in the concave part of the second Ru underlayer 20.

The buffer layer 22 is a layer for improving the separation between columnar CoPt alloy magnetic crystal grains in the granular structure of the perpendicular magnetic recording layer 24. For example, a Ru₅₀Co₂₅Cr₂₅- 30 vol % TiO₂ layer or the like can be used as the buffer layer 22.

The perpendicular magnetic recording layer 24 is a layer for performing magnetic recording, and its layer structure is a granular structure. As the perpendicular magnetic recording layer 24, for example, a Co₈₀Pt₂₀- 30 vol % B₂O₃ layer or the like can be used, and in this case, the columnar CoPt alloy magnetic crystal grains 24A are separated by the non-magnetic grain boundary oxide 24B (B₂O₃) (see FIGS. 2 and 3). The thickness of the perpendicular magnetic recording layer 24 is about 16 nm, for example.

The cap layer 26 covers the perpendicular magnetic recording layer 24, and is a layer for improving the thermal stability of the perpendicular magnetic recording layer 24 and reducing the switching magnetic field (the magnetic field necessary for magnetization reversal of the magnetic crystal grains), by appropriately adjusting the intergranular exchange coupling between the CoPt alloy magnetic crystal grains 24A of the perpendicular magnetic recording layer 24. The cap layer 26 has a granular structure having CoPt alloy magnetic crystal grains 26A and a magnetic grain boundary oxide 26B (see FIGS. 2 and 3). For example, Co₈₀Pt₂₀- 30 vol % magnetic oxide (Gd₂O₃, Nd₂O₃, Sm₂₃, CeO₂, etc.) can be used as the cap layer 26, in which case the cap layer 26 is a granular structure in which the columnar CoPt alloy magnetic crystal grains 26A are divided by the magnetic grain boundary oxide 26B (Gd₂O₃, Nd₂O₃, Sm₂O₃, CeO₂, etc.) The thickness of the cap layer 26 can be determined appropriately depending on the size required for the intergranular exchange coupling between the CoPt alloy magnetic crystal grains 24A of the perpendicular magnetic recording layer 24 and the size of the intergranular exchange coupling 26C between the CoPt alloy magnetic crystal grains 26A of the cap layer 26. The thickness of the cap layer 26 is, for example, 1 nm or more and 9 nm or less.

The surface protection layer 28 is a layer for protecting the surface of the perpendicular magnetic recording medium 10. For example, a protective film consisting mainly of carbon can be used as the surface protection layer 28, and the thickness of the surface protection layer 28 is 7 nm, for example.

### (2) Further Explanation of the Composition of the Cap Layer 26

The cap layer 26 has a granular structure having the CoPt alloy magnetic crystal grains 26A and the magnetic grain boundary oxide 26B, as described above, and the CoPt alloy magnetic crystal grains 26A of the cap layer 26 contain Co in a range of 65 at % or more and 90 at % or less and Pt in a range of 10 at % or more and 35 at % or less. From the viewpoint of increasing more the coercive force Hc of the perpendicular magnetic recording medium 10, the CoPt alloy magnetic crystal grains 26A of the cap layer 26 preferably contain Co in a range of 70 at % or more and 75 at % or less and Pt in a range of 25 at % or more and 30 at % or less.

The CoPt alloy magnetic crystal grains 26A of the cap layer 26 may contain Co in a range of 70 at % or more and less than 85 at % Pt in a range of 10 at % or more and 20 at % or less, and at least one element of Cr, Ti, B, Mb, Ta, Nb, W, and Ru in a range of 0.5 at % or more and 15 at % or less.

From the viewpoint of increasing more the coercive force Hc of the perpendicular magnetic recording medium 10 and increasing the intergranular exchange coupling 26C of the CoPt alloy magnetic crystal grains 26A of the cap layer 26 to reduce the saturation magnetic field Hs of the perpendicular magnetic recording medium 10, the volume fraction of the magnetic grain boundary oxide 26B to the entire cap layer 26 is preferably 5 vol % or more and 40 vol % or less, more preferably 10 vol % or more and 35 vol % or less, and particularly preferably 15 vol % or more and 30 vol % or less. Depending on the characteristics required for the perpendicular magnetic recording medium 10, the volume fraction of the magnetic grain boundary oxide 26B to the entire cap layer 26 may be determined accordingly.

The magnetic grain boundary oxide 26B of the cap layer 26 is preferably a rare earth oxide from the viewpoint of increasing the magnetism, and is preferably an oxide of at least one element of Gd, Nd, Sm, Ce, Eu, La, Pr, Ho, Er, Yb, and Tb, specifically.

The magnetic grain boundary oxide 26B of the cap layer 26 does not have to be a rare earth oxide. Specifically, the following magnetic oxides, for example, Fe₂O₃, Fe₃O₄, CoFe₂O₄, MnTi_{0.44}Fe_{1.56}O₄, Mn_{0.4}Co_{0.3}Fe₂O₄, Co_{1.1}Fe_{2.2}O₄, Co_{0.7}Zn_{0.3}Fe₂O₄, Ni_{0.35}Fe_{1.3}O₄, NiFe₂O₄, Li_{0.3}Fe_{2.5}O₄, Fe_{2.69}Ti_{0.31}O₄, Mn_{0.98}Fe_{2.02}O₄, Mn_{0.8}Zn_{0.2}Fe₂O₄, Y₂Fe₅O₁₂, Y₃Al_{0.83}Fe_{4.17}O₁₂, Y₃Ga_{0.4}Fe_{4.6}O₁₂, Bi_{0.2}Ca_{2.8}V_{1.4}Fe_{3.6}O₁₂, Y_{1.4}Ca_{1.26}V_{0.63}Fe_{4.37}O₁₂, Y₂Gd₁Fe₅O₁₂, Y_{1.2}Gd_{1.8}Fe₅O₁₂, Y_{2.64}Gd_{0.36}Al_{0.56}Fe_{4.44}O₁₂, Y_{2.36}Gd_{0.64}Al_{0.43}Fe_{4.57}O₁₂, BaFe₁₂O₁₉, BaFe₁₈O₂₇, BaZnFe₁₇O₂₇, BaZn_{1.5}Fe_{17.5}O₂₇, BaMnFe₁₆O₂₇, BaNi₂Fe₁₆O₂₇, BaNi_{0.5}ZnFe_{16.5}O₂₇, Ba₄Zn₂Fe₃₆O₆₉, GdFeO₃, SrFe₁₂O₁₉Sn_{0.985}Mn_{0.015}O₂, In_{1.75}Sn_{0.2}Mn_{0.05}, etc. can also be used as the magnetic grain boundary oxide 26B of the cap layer 26.

### (3) Function Effect of the Cap layer 26

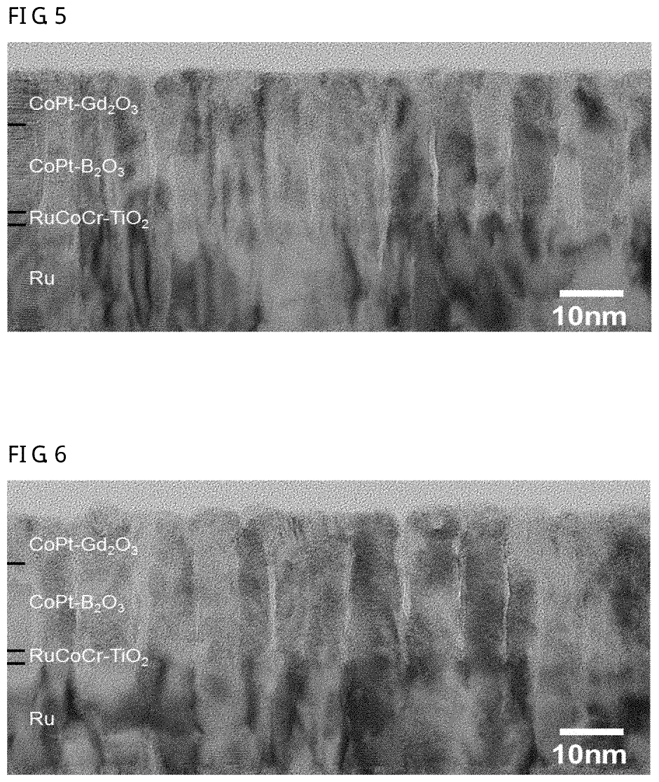

As mentioned above, FIG. 2 is a vertical cross-sectional diagram schematically illustrating a portion of a vertical cross section of the perpendicular magnetic recording medium 10 according to the present embodiment, and FIG. 3 is a vertical cross-sectional diagram schematically illustrating a portion of a vertical cross section of the perpendicular magnetic recording medium 10 (after optimizing the cap layer 26) according to the present embodiment. FIG. 4 is a vertical cross-sectional diagram schematically illustrating a portion of a vertical cross section of a current perpendicular magnetic recording medium 100. In FIGS. 2 and 3, the intergranular exchange coupling 26C between the CoPt alloy magnetic crystal grains 26A of the cap layer 26 is schematically represented by spring-like lines, and similarly, in FIG. 4, the intergranular exchange coupling 1028 between the CoPt alloy magnetic crystal grains 102A of a cap layer 102 is schematically represented by spring-like lines.

Referring to FIGS. 2 t o 4, the function effect of the cap layer 26 will be described in detail. For the sake of explanation, it is assumed here that a Co₈₀Pt₂₀- 30 vol % B₂O₃ layer is used as the perpendicular magnetic recording layer 24 and a Co₈₀Pt₂₀- 30 vol % Gd₂O₃ layer is used as the cap layer 26. A Ru₅₀Co₂₅Cr₂₅- 30 vol % TiO₂ layer is assumed to be used as the buffer layer 22. In addition, a CoPtCrB alloy is assumed to be used as the cap layer 102 of the current perpendicular magnetic recording medium 100.

The cap layer 26 is a layer for appropriately adjusting the intergranular exchange coupling between the CoPt alloy magnetic crystal grains 24A in the perpendicular magnetic recording layer 24 to improve the thermal stability of the perpendicular magnetic recording layer 24 and to reduce the switching magnetic field (a magnetic field necessary for magnetization reversal of the magnetic crystal grains). The perpendicular magnetic recording layer 24 itself is a granular structure, and the CoPt alloy magnetic crystal grains 24A are separated by the non-magnetic grain boundary oxide 24B (B₂O₃). Therefore, the intergranular exchange coupling between the CoPt alloy magnetic crystal grains 24A is small in the perpendicular magnetic recording layer 24 itself, and thus, the thermal stability is insufficient and reduction of the switching magnetic field is also insufficient.

The cap layer 26 serves to compensate for the intergranular exchange coupling between the CoPt alloy magnetic crystal grains 24A, which is lacking in the perpendicular magnetic recording layer 24 itself, and for this reason, it is necessary to increase the intergranular exchange coupling 26C between the CoPt alloy magnetic crystal grains 26A to some extent in the cap layer 26.

Therefore, in the cap layer 26 of the perpendicular magnetic recording medium 10 according to the present embodiment, a magnetic oxide (a rare earth oxide is preferred because of its large magnetism) is used as an oxide to form the magnetic grain boundary oxide 26B, so that the intergranular exchange coupling 26C between the CoPt alloy magnetic crystal grains 26A in the cap layer 26 is enlarged to some extent. As the result, the intergranular exchange coupling between the CoPt alloy magnetic crystal grains 24A in the perpendicular magnetic recording layer 24 can also be appropriately supplemented.

The intergranular exchange coupling 26C between the CoPt alloy magnetic grains 26A in the cap layer 26 is controlled by the thickness of the cap layer 26. As the thickness of the cap layer 26 increases, the intergranular exchange coupling 26C between the CoPt alloy magnetic crystal grains 26A in the cap layer 26 increases. The thickness of the cap layer 26 can be determined according to the size of the required intergranular exchange coupling 26C. From the viewpoint of not reducing the coercive force Hc, the thickness of the cap layer 26 is preferably 1 nm or more and 7 nm or less.

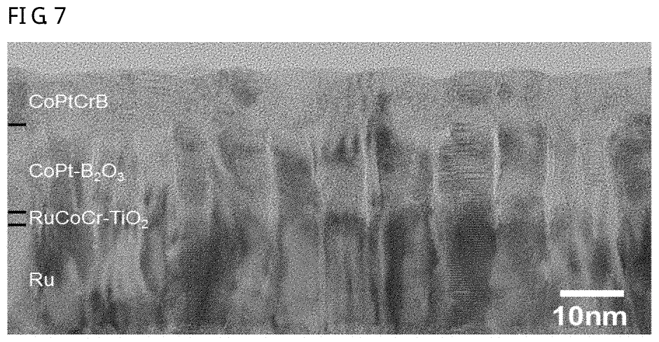

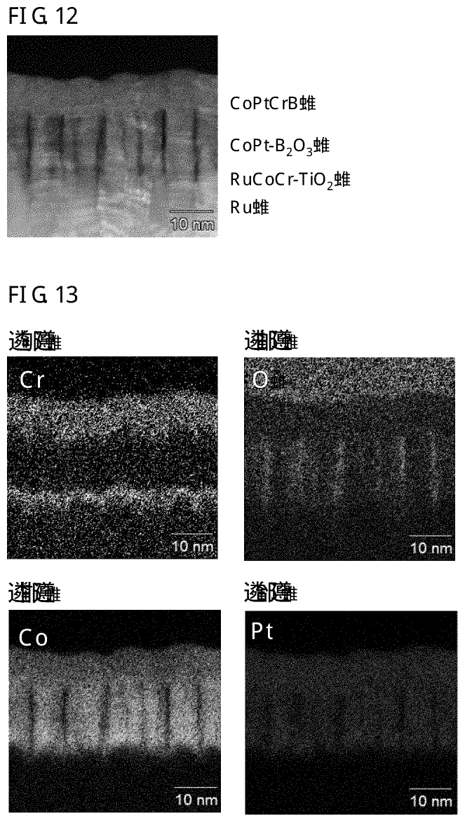

FIG. 4 is a vertical cross-sectional diagram schematically illustrating a portion of a vertical cross section of the current perpendicular magnetic recording medium 100, wherein, as shown in FIG. 4, a void 104 is generated over the non-magnetic grain boundary oxide 24B (B₂O₃) of the perpendicular magnetic recording layer 24. The cap layer 102 of the current perpendicular magnetic recording medium 100 is a CoPtCrB alloy and does not contain oxides, so that it is difficult to wet the non-magnetic grain boundary oxide 24B (B₂O₃) of the perpendicular magnetic recording layer 24, and therefore, it is thought that the void 104 is generated over the non-magnetic grain boundary oxide 24B (B₂O₃) of the perpendicular magnetic recording layer 24. Even if no voids 104 are observed in the current perpendicular magnetic recording media, as can be read from the cross-sectional TEM photographs shown later as FIG. 7 (Comparative Example 20), the dark field image shown later as FIG. 12 (Comparative Example 20), and the measurement results of energy dispersive X-ray analysis (EDX) shown later as FIG. 13 (Comparative Example 20), in the current perpendicular magnetic recording media, the boundary surface between the perpendicular magnetic recording layer (CoPt-B₂O₃ layer) and the cap layer (CoPtCrB layer) is wavy and the unevenness of the surface is large.

Therefore, the cap layer 102 of the current perpendicular magnetic recording medium 100 has a large unevenness in its thickness direction (i.e., a large unevenness in cross section when the cap layer 102 is cut at different positions in the thickness direction by a plane orthogonal to the thickness direction), so that the magnitude of the intergranular exchange coupling 102B between the CoPt alloy magnetic grains 102A in the cap layer 102 does not change precisely proportional to the thickness of the cap layer even if the thickness of the cap layer 102 is varied. Consequently, it is difficult to accurately control the magnitude of the intergranular exchange coupling 102B between the CoPt alloy magnetic grains 102A in the cap layer 102, even if the thickness of the cap layer 102 is controlled.

In contrast, as shown in FIG. 2, the cap layer 26 of the perpendicular magnetic recording medium 10 according to the present embodiment is a Co₈₀Pt₂₀- 30 vol % Gd₂O₃ layer and has a magnetic oxide Gd₂O₃, and the magnetic grain boundary oxide 26B (Gd₂O₃), which is easily wetted with B₂O₃, is formed on top of the non-magnetic grain boundary oxide 24B (B₂O₃) of the perpendicular magnetic recording layer 24, and thus no voids are generated. Therefore, since the cap layer 26 of the perpendicular magnetic recording medium 10 according to the present embodiment has a high degree of uniformity in its thickness direction (the cross sections of the cap layer 26 when cut at different positions in the thickness direction in a plane orthogonal to the thickness direction are all nearly identical), when the thickness of the cap layer 26 is changed, in proportion to the thickness, the magnitude of the intergranular exchange coupling 26C between the CoPt alloy magnetic crystal grains 26A of the cap layer 26 changes. Therefore, by controlling the thickness of the cap layer 26, the magnitude of the intergranular exchange coupling 26C between the CoPt alloy magnetic crystal grains 26A in the cap layer 26 can be accurately controlled.

As described above, the cap layer 26 of the perpendicular magnetic recording medium 10 according to the present embodiment has a granular structure having the CoPt alloy magnetic crystal grains 26A and the magnetic grain boundary oxide 26B. The magnetic grain boundary oxide 26B (Gd₂O₃) are magnetic, and the intergranular exchange coupling 26C between the CoPt alloy magnetic crystal grains 26A in the cap layer 26 is increased.

Since the cap layer 26 of the perpendicular magnetic recording medium 10 according to the present embodiment has a high degree of uniformity in its thickness direction (the cross sections of the cap layer 26 when cut at different positions in the thickness direction in a plane orthogonal to the thickness direction are all nearly identical), it is possible to accurately control the magnitude of the intergranular exchange coupling 26C between the CoPt alloy magnetic crystal grains 26A in the cap layer 26 by controlling the thickness of the cap layer 26.

Therefore, in the perpendicular magnetic recording medium 10 according to the present embodiment, by controlling the thickness of the cap layer 26, the magnitude of the intergranular exchange coupling 26C between the CoPt alloy magnetic crystal grains 26A in the cap layer 26 can be accurately controlled, and thus the magnitude of the intergranular exchange coupling between the CoPt alloy magnetic crystal grains 24A in the perpendicular magnetic recording layer 24 can be accurately controlled.

FIG. 3 is a vertical cross-sectional diagram schematically illustrating a portion of a vertical cross section of the perpendicular magnetic recording medium 10 (after optimizing the cap layer 26) according to the present embodiment, as described above.

In the optimized state of the cap layer 26 in the perpendicular magnetic recording medium 10 according to the present embodiment, the thickness of the magnetic grain boundary oxide 26B (Gd₂O₃) in the cross section in the direction orthogonal to the thickness direction is minimized, and the surface unevenness of the cap layer 26 is also minimized.

By minimizing the thickness of the magnetic grain boundary oxide 26B (Gd₂O₃) in the cap layer 26 (the distance between the CoPt alloy magnetic grains 26A in the cap layer 26), the strength of the intergranular exchange coupling 26C between the CoPt alloy magnetic grains 26A in the cap layer 26 can be strengthened. Therefore, even if the cap layer 26 is made thinner, the strength of the intergranular exchange coupling 26C between the CoPt alloy magnetic crystal grains 26A in the cap layer 26 can be controlled to a certain degree. By minimizing the surface unevenness of the cap layer 26, the magnitude of the intergranular exchange coupling 26C between the CoPt alloy magnetic crystal grains 26A in the cap layer 26 can be more accurately controlled by controlling the thickness of the cap layer 26, and thus the magnitude of intergranular exchange coupling between magnetic grains 24A in the CoPt alloy of the intergranular magnetic recording layer 24 can be controlled more accurately.

### (4) Sputtering Target for Forming the Cap Layer 26

### (4-1) Composition of Sputtering Targets

The sputtering target used for forming the cap layer 26 has the same composition as the cap layer 26 and contains metals and a magnetic oxide, and specifically, for example, contains Co in a range of 65 at % or more and 90 at % or less and Pt in a range of 10% or more and 35 at % or less to the total of the metals, and contains the magnetic oxide in a range of 5 vol % or more and 40 vol % or less to the total of the sputtering target. Also, specifically, for example, the sputtering target contains Co in a range of 70 at % or more and less than 85 at % and Pt in a range of 10% or more and 20 at % or less, and one or more elements of Cr, Ti , B, Mb, Ta, Nb, W, and Ru in a range of 0.5 at % or more and 15 at % or less to the total of the metals, and contains a magnetic oxide in a range of 5 vol % or more and 40 vol % or less to the entire sputtering target.

### (4-2) Production Method for Sputtering Targets

Next, production method for sputtering targets for forming the cap layer 26 will be described, taking a sputtering target whose composition is Co₈₀Pt₂₀- 30 vol % Gd₂O₃ as an example. However, the production method for the sputtering target for forming the cap layer 26 is not limited to the following specific examples.

First, the metal Co and the metal Pt are weighed so that the atomic ratio of the metal Co is 80 at % and the atomic ratio of the metal Pt is 20 at % to the total of the metal Co and the metal Pt, and a molten CoPt alloy is prepared. Then, gas atomization is performed to prepare CoPt alloy atomized powder. The prepared CoPt alloy atomized powder is classified so that the particle diameter becomes not larger than a predetermined particle diameter (for example, 106≈m or smaller).

Gd₂O₃ powder is added to the prepared CoPt alloy atomized powder so as to be 30 vol % and mixed and dispersed with a ball mill to prepare a powder mixture for pressure sintering. By mixing and dispersing the CoPt alloy atomized powder and the Gd₂O₃ powder with a ball mill, a powder mixture for pressure sintering in which the CoPt alloy atomized powder and the Gd₂O₃ powder are finely dispersed can be prepared.

As described above, from the viewpoint of increasing more the coercive force Hc of the perpendicular magnetic recording medium 10 and the viewpoint of increasing the intergranular exchange coupling 26C of the CoPt alloy magnetic crystal grains 26A of the cap layer 26 to reduce the saturation magnetic field Hs of the perpendicular magnetic recording medium 10, the volume fraction of the magnetic grain boundary oxide 26B to the entire cap layer 26 is preferably 5 vol % or more and 40 vol % or less. Therefore, it is preferable to make the volume fraction of the Gd₂O₃ powder to the total of the mixed powder for pressure sintering to be 5 vol % or more and 40 vol % or less.

The prepared powder mixture for pressure sintering is pressure-sintered and molded using, for example, a vacuum hot press method to produce a sputtering target. Since the prepared powder mixture for pressure sintering is mixed and dispersed with a ball mill, and the CoPt alloy atomized powder and the Gd₂O₃ powder are finely dispersed, defects such as generation of modules and particles are unlikely to occur during sputtering by using the sputtering targets obtained by this production method.

The method for pressure sintering the powder mixture for pressure sintering is not particularly limited. The method may be a method other than the vacuum hot press method, and may be, for example, the HIP method or the like.

In the example of the production method described above, the CoPt alloy atomized powder is prepared using the atomization method, and a Gd₂O₃ powder is added to the prepared CoPt alloy atomized powder and mixed and dispersed with the ball mill to prepare the powder mixture for pressure sintering. Instead of using the CoPt alloy atomized powder, a Co single powder and a Pt single powder may be used. In this case, a Co single powder, a Pt single powder, and a Gd₂O₃ powder are mixed and dispersed with a ball mill to prepare a powder mixture for pressure sintering.

### EXAMPLES

The following describes examples and comparative examples, as well as the experimental data obtained in connection with the present invention.

### Examples 1 to 142, Comparative Examples 1 to 20

The perpendicular magnetic recording media of Examples 1 to 142 and Comparative Examples 2 to 20 were produced with the same layer structure as in FIG. 1 (a layer structure in which an adhesion layer 14, a seed layer 16, a first Ru underlayer 18, a second Ru underlayer 20, a buffer layer 22, a perpendicular magnetic recording layer 24, a cap layer 26, and a surface protection layer 28 are formed in sequence on a substrate 12). Specifically, the following steps were taken.

As the substrate 12, a glass substrate was used.

As the adhesion layer 14, a Ta layer was deposited with a thickness of 5 nm under the conditions of an argon gas pressure of 0.6 Pa and supplying power of 500 W.

As the seed layer 16, a Ni₉₀W₁₀ layer was deposited with a thickness of 6 nm under the conditions of an argon gas pressure of 0.6 Pa and supplying power of 500 W.

As the first Ru underlayer 18, a Ru layer was deposited with a thickness of 10 nm under the conditions of an argon gas pressure of 0.6 Pa and supplying power of 500 W.

As the second Ru underlayer 20, a Ru layer was deposited with a thickness of 10 nm under the conditions of an argon gas pressure of 8.0 Pa and supplying power of 500 W.

As the buffer layer 22, a Ru₅₀Co₂₅Cr₂₅- 30 vol % TiO₂ layer was deposited with a thickness of 2 nm under the conditions of an argon gas pressure of 0.6 Pa and supplying power of 300 W.

As the perpendicular magnetic recording layer 24, a Co₈₀Pt₂₀- 30 vol % B₂O₃ layer was deposited with a thickness of 16 nm under the conditions of an argon gas pressure of 4.0 Pa and supplying power of 500 W.

As the cap layer 26, a sputtering target produced as described in “(4) Sputtering target for forming the cap layer 26” above was used under the conditions of an argon gas pressure of 0.6 Pa or 4.0 Pa and supplying power of 500 W to deposit a CoPt alloy-magnetic grain boundary oxide with the compositions and thicknesses shown in Tables 1-4.

As the surface protection layer 28, carbon was deposited with a thickness of 7 nm under the conditions of an argon gas pressure of 0.6 Pa and supplying power of 300 W.

As a comparative example 1, a perpendicular magnetic recording medium in which the cap layer 26 was deleted in the above structure was produced.

The conditions that were changed in Examples 1-142 and Comparative Examples 2-20 are the composition of the cap layer, the thickness of the cap layer, and the argon gas pressure at the time of cap layer deposition. Comparative Example 20 is a comparative example in which, as the cap layer thereof, the cap layer (CoPtCrB) of the current perpendicular magnetic recording media was used.

The magnetic properties of the produced perpendicular magnetic recording media of Examples 1-142 and Comparative Examples 1-20 were measured using a sample vibrating magnetometer (Squid-VSM) (manufacturing company: QUANTUM DESIGN, product number: MPMS3) using a super conducting quantum interference device, a high-sensitivity magnetic anisotropy torque meter (torque magnetometer) (manufacturing company: TAMAKAWA CO., Ltd., product number: TM-TR2050-HGC), and Magneto Optical Kerr Effect (MOKE) measurement apparatus. In addition, the microstructure of the cap layers of the produced perpendicular magnetic recording media of Examples 1-142 and Comparative Examples 1-20 were observed using planar TEM-EDX and cross-sectional TEM-EDX.

Tables 1 to 4 below show the coercive force Hc and saturation magnetic field Hs measured for the perpendicular magnetic recording media of Examples 1 to 142 and Comparative Examples 1 to 20. The coercive force Hc and saturation magnetic field Hs were determined from the hysteresis loops measured using a sample vibrating magnetometer (Squid-VSM).

In Tables 1-4, the thickness indicates the thickness of the cap layer, and the Ar gas pressure indicates the Ar gas pressure at the time of cap layer deposition.

TABLE 1

| | Composition of | Thickness | Ar gas | Hc | Hs |
|---|---|---|---|---|---|
| | cap layer | (nm) | pressure (Pa) | (kOe) | (kOe) |
| Comparative Example 01 | None | 0 | 4.0 | 9.3 | 21.5 |
| Comparative Example 02 | Co₈₀Pt₂₀-30 vol % B₂O₃ | 2 | 4.0 | 7.5 | 21.0 |
| Comparative Example 03 | Co₈₀Pt₂₀-30 vol % B₂O₃ | 4 | 4.0 | 7.9 | 21.5 |
| Comparative Example 04 | Co₈₀Pt₂₀-30 vol % B₂O₃ | 6 | 4.0 | 7.7 | 21.5 |
| Comparative Example 05 | Co₈₀Pt₂₀-30 vol % B₂O₃ | 8 | 4.0 | 7.0 | 21.0 |
| Comparative Example 06 | Co₈₀Pt₂₀-30 vol % B₂O₃ | 1 | 0.6 | 7.5 | 20.0 |
| Comparative Example 07 | Co₈₀Pt₂₀-30 vol % B₂O₃ | 2 | 0.6 | 8.5 | 20.5 |
| Comparative Example 08 | Co₈₀Pt₂₀-30 vol % B₂O₃ | 3 | 0.6 | 8.5 | 20.0 |
| Comparative Example 09 | Co₈₀Pt₂₀-30 vol % B₂O₃ | 4 | 0.6 | 8.5 | 20.5 |
| Comparative Example 10 | Co₈₀Pt₂₀-30 vol % B₂O₃ | 5 | 0.6 | 8.0 | 20.0 |
| Comparative Example 11 | Co₈₀Pt₂₀-30 vol % B₂O₃ | 6 | 0.6 | 8.2 | 20.3 |
| Comparative Example 12 | Co₈₀Pt₂₀-30 vol % B₂O₃ | 7 | 0.6 | 8.0 | 20.5 |
| Comparative Example 13 | Co₈₀Pt₂₀-30 vol % B₂O₃ | 8 | 0.6 | 7.7 | 20.5 |
| Comparative Example 14 | Co₈₀Pt₂₀-30 vol % B₂O₃ | 9 | 0.6 | 7.7 | 20.0 |
| Comparative Example 15 | Co₈₀Pt₂₀-4 vol % Gd₂O₃ | 5 | 0.6 | 4.5 | 10.0 |
| Comparative Example 16 | Co₈₀Pt₂₀-41 vol % Gd₂O₃ | 5 | 0.6 | 8.5 | 20.0 |
| Comparative Example 17 | Co₉₅Pt₅-30 vol % Gd₂O₃ | 5 | 0.6 | 4.0 | 12.5 |
| Comparative Example 18 | Co₆₀Pt₄₀-30 vol % Gd₂O₃ | 5 | 0.6 | 4.5 | 13.0 |
| Comparative Example 19 | Co₆₅Pt₂₀Cr₁₅-30 vol % Gd₂O₃ | 5 | 0.6 | 4.5 | 13.5 |
| Comparative Example 20 | Co Pt Cr B | 9 | 0.6 | 4.9 | 12.5 |
| Example 1 | Co₈₀Pt₂₀-30 vol % Gd₂O₃ | 2 | 4.0 | 8.0 | 19.0 |
| Example 2 | Co₈₀Pt₂₀-30 vol % Gd₂O₃ | 3 | 4.0 | 8.5 | 19.0 |
| Example 3 | Co₈₀Pt₂₀-30 vol % Gd₂O₃ | 4 | 4.0 | 8.4 | 19.0 |
| Example 4 | Co₈₀Pt₂₀-30 vol % Gd₂O₃ | 5 | 4.0 | 8.9 | 19.0 |
| Example 5 | Co₈₀Pt₂₀-30 vol % Gd₂O₃ | 6 | 4.0 | 8.5 | 19.0 |
| Example 6 | Co₈₀Pt₂₀-30 vol % Gd₂O₃ | 7 | 4.0 | 8.5 | 19.0 |
| Example 7 | Co₈₀Pt₂₀-30 vol % Gd₂O₃ | 8 | 4.0 | 7.7 | 17.7 |
| Example 8 | Co₈₀Pt₂₀-30 vol % Gd₂O₃ | 9 | 4.0 | 7.0 | 16.0 |
| Example 9 | Co₈₀Pt₂₀-30 vol % Gd₂O₃ | 1 | 0.6 | 7.6 | 19.0 |
| Example 10 | Co₈₀Pt₂₀-30 vol % Gd₂O₃ | 2 | 0.6 | 7.5 | 18.5 |
| Example 11 | Co₈₀Pt₂₀-30 vol % Gd₂O₃ | 3 | 0.6 | 7.5 | 17.5 |
| Example 12 | Co₈₀Pt₂₀-30 vol % Gd₂O₃ | 4 | 0.6 | 7.6 | 18.0 |
| Example 13 | Co₈₀Pt₂₀-30 vol % Gd₂O₃ | 5 | 0.6 | 7.0 | 17.0 |
| Example 14 | Co₈₀Pt₂₀-30 vol % Gd₂O₃ | 6 | 0.6 | 8.6 | 19.0 |
| Example 15 | Co₈₀Pt₂₀-30 vol % Gd₂O₃ | 7 | 0.6 | 7.5 | 16.5 |
| Example 16 | Co₈₀Pt₂₀-30 vol % Gd₂O₃ | 8 | 0.6 | 6.4 | 14.0 |
| Example 17 | Co₈₀Pt₂₀-30 vol % Gd₂O₃ | 9 | 0.6 | 5.5 | 12.5 |
| Example 18 | Co₈₀Pt₂₀-30 vol % Nd₂O₃ | 2 | 4.0 | 7.1 | 17.5 |
| Example 19 | Co₈₀Pt₂₀-30 vol % Nd₂O₃ | 3 | 4.0 | 8.0 | 19.0 |
| Example 20 | Co₈₀Pt₂₀-30 vol % Nd₂O₃ | 4 | 4.0 | 7.7 | 17.0 |
| Example 21 | Co₈₀Pt₂₀-30 vol % Nd₂O₃ | 5 | 4.0 | 7.2 | 17.5 |
| Example 22 | Co₈₀Pt₂₀-30 vol % Nd₂O₃ | 6 | 4.0 | 7.3 | 18.0 |
| Example 23 | Co₈₀Pt₂₀-30 vol % Nd₂O₃ | 7 | 4.0 | 7.2 | 16.5 |
| Example 24 | Co₈₀Pt₂₀-30 vol % Nd₂O₃ | 8 | 4.0 | 7.5 | 16.8 |
| Example 25 | Co₈₀Pt₂₀-30 vol % Nd₂O₃ | 9 | 4.0 | 6.0 | 14.0 |
| Example 26 | Co₈₀Pt₂₀-30 vol % Nd₂O₃ | 1 | 0.6 | 7.4 | 16.8 |
| Example 27 | Co₈₀Pt₂₀-30 vol % Nd₂O₃ | 2 | 0.6 | 7.3 | 17.2 |
| Example 28 | Co₈₀Pt₂₀-30 vol % Nd₂O₃ | 3 | 0.6 | 7.5 | 17.0 |
| Example 29 | Co₈₀Pt₂₀-30 vol % Nd₂O₃ | 4 | 0.6 | 7.3 | 19.0 |
| Example 30 | Co₈₀Pt₂₀-30 vol % Nd₂O₃ | 5 | 0.6 | 8.2 | 19.0 |
| Example 31 | Co₈₀Pt₂₀-30 vol % Nd₂O₃ | 6 | 0.6 | 8.1 | 18.5 |
| Example 32 | Co₈₀Pt₂₀-30 vol % Nd₂O₃ | 7 | 0.6 | 7.0 | 16.0 |
| Example 33 | Co₈₀Pt₂₀-30 vol % Nd₂O₃ | 8 | 0.6 | 7.1 | 16.0 |
| Example 34 | Co₈₀Pt₂₀-30 vol % Nd₂O₃ | 9 | 0.6 | 7.2 | 15.3 |

TABLE 2

| | Composition of | Thickness | Ar gas | Hc | Hs |
|---|---|---|---|---|---|
| | cap layer | (nm) | pressure (Pa) | (kOe) | (kOe) |
| Example 35 | Co₈₀Pt₂₀-30 vol % Sm₂O₃ | 2 | 4.0 | 8.4 | 18.8 |
| Example 36 | Co₈₀Pt₂₀-30 vol % Sm₂O₃ | 3 | 4.0 | 8.1 | 18.5 |
| Example 37 | Co₈₀Pt₂₀-30 vol % Sm₂O₃ | 4 | 4.0 | 7.3 | 17.0 |
| Example 38 | Co₈₀Pt₂₀-30 vol % Sm₂O₃ | 5 | 4.0 | 7.5 | 16.5 |
| Example 39 | Co₈₀Pt₂₀-30 vol % Sm₂O₃ | 6 | 4.0 | 7.7 | 17.3 |
| Example 40 | Co₈₀Pt₂₀-30 vol % Sm₂O₃ | 7 | 4.0 | 6.7 | 16.0 |
| Example 41 | Co₈₀Pt₂₀-30 vol % Sm₂O₃ | 8 | 4.0 | 7.1 | 16.0 |
| Example 42 | Co₈₀Pt₂₀-30 vol % Sm₂O₃ | 9 | 4.0 | 6.7 | 14.5 |
| Example 43 | Co₈₀Pt₂₀-30 vol % Sm₂O₃ | 1 | 0.6 | 7.7 | 17.0 |
| Example 44 | Co₈₀Pt₂₀-30 vol % Sm₂O₃ | 2 | 0.6 | 8.1 | 18.0 |
| Example 45 | Co₈₀Pt₂₀-30 vol % Sm₂O₃ | 3 | 0.6 | 8.2 | 19.0 |
| Example 46 | Co₈₀Pt₂₀-30 vol % Sm₂O₃ | 4 | 0.6 | 8.1 | 18.3 |
| Example 47 | Co₈₀Pt₂₀-30 vol % Sm₂O₃ | 5 | 0.6 | 7.2 | 16.5 |
| Example 48 | Co₈₀Pt₂₀-30 vol % Sm₂O₃ | 6 | 0.6 | 7.7 | 17.0 |
| Example 49 | Co₈₀Pt₂₀-30 vol % Sm₂O₃ | 7 | 0.6 | 7.7 | 17.0 |
| Example 50 | Co₈₀Pt₂₀-30 vol % Sm₂O₃ | 8 | 0.6 | 7.4 | 16.0 |
| Example 51 | Co₈₀Pt₂₀-30 vol % Sm₂O₃ | 9 | 0.6 | 6.6 | 14.3 |
| Example 52 | Co₈₀Pt₂₀-30 vol % CeO₂ | 2 | 4.0 | 8.8 | 18.8 |
| Example 53 | Co₈₀Pt₂₀-30 vol % CeO₂ | 3 | 4.0 | 8.2 | 19.0 |
| Example 54 | Co₈₀Pt₂₀-30 vol % CeO₂ | 4 | 4.0 | 8.9 | 19.0 |
| Example 55 | Co₈₀Pt₂₀-30 vol % CeO₂ | 5 | 4.0 | 9.0 | 19.0 |
| Example 56 | Co₈₀Pt₂₀-30 vol % CeO₂ | 6 | 4.0 | 8.1 | 18.5 |
| Example 57 | Co₈₀Pt₂₀-30 vol % CeO₂ | 7 | 4.0 | 7.2 | 17.0 |
| Example 58 | Co₈₀Pt₂₀-30 vol % CeO₂ | 8 | 4.0 | 7.4 | 16.5 |
| Example 59 | Co₈₀Pt₂₀-30 vol % CeO₂ | 9 | 4.0 | 6.2 | 14.8 |
| Example 60 | Co₈₀Pt₂₀-30 vol % CeO₂ | 1 | 0.6 | 7.7 | 18.0 |
| Example 61 | Co₈₀Pt₂₀-30 vol % CeO₂ | 3 | 0.6 | 8.6 | 19.0 |
| Example 62 | Co₈₀Pt₂₀-30 vol % CeO₂ | 4 | 0.6 | 8.1 | 18.0 |
| Example 63 | Co₈₀Pt₂₀-30 vol % CeO₂ | 5 | 0.6 | 8.0 | 18.0 |
| Example 64 | Co₈₀Pt₂₀-30 vol % CeO₂ | 6 | 0.6 | 7.2 | 16.5 |
| Example 65 | Co₈₀Pt₂₀-30 vol % CeO₂ | 7 | 0.6 | 7.2 | 16.5 |
| Example 66 | Co₈₀Pt₂₀-30 vol % CeO₂ | 8 | 0.6 | 6.9 | 15.0 |
| Example 67 | Co₈₀Pt₂₀-30 vol % CeO₂ | 9 | 0.6 | 5.7 | 13.0 |
| Example 68 | Co₈₀Pt₂₀-30 vol % Eu₂O₃ | 1 | 0.6 | 8.0 | 19.0 |
| Example 69 | Co₈₀Pt₂₀-30 vol % Eu₂O₃ | 2 | 0.6 | 8.1 | 19.0 |
| Example 70 | Co₈₀Pt₂₀-30 vol % Eu₂O₃ | 3 | 0.6 | 8.1 | 19.0 |
| Example 71 | Co₈₀Pt₂₀-30 vol % Eu₂O₃ | 4 | 0.6 | 8.0 | 18.3 |
| Example 72 | Co₈₀Pt₂₀-30 vol % Eu₂O₃ | 5 | 0.6 | 7.5 | 17.5 |
| Example 73 | Co₈₀Pt₂₀-30 vol % Eu₂O₃ | 6 | 0.6 | 7.7 | 17.0 |
| Example 74 | Co₈₀Pt₂₀-30 vol % Eu₂O₃ | 7 | 0.6 | 7.3 | 17.0 |
| Example 75 | Co₈₀Pt₂₀-30 vol % Eu₂O₃ | 8 | 0.6 | 7.1 | 15.5 |
| Example 76 | Co₈₀Pt₂₀-30 vol % Eu₂O₃ | 9 | 0.6 | 6.6 | 14.0 |
| Example 77 | Co₈₀Pt₂₀-30 vol % La₂O₃ | 1 | 0.6 | 7.5 | 19.0 |
| Example 78 | Co₈₀Pt₂₀-30 vol % La₂O₃ | 2 | 0.6 | 7.3 | 18.5 |
| Example 79 | Co₈₀Pt₂₀-30 vol % La₂O₃ | 3 | 0.6 | 7.2 | 17.5 |
| Example 80 | Co₈₀Pt₂₀-30 vol % La₂O₃ | 4 | 0.6 | 7.1 | 18.0 |
| Example 81 | Co₈₀Pt₂₀-30 vol % La₂O₃ | 5 | 0.6 | 7.0 | 17.0 |
| Example 82 | Co₈₀Pt₂₀-30 vol % La₂O₃ | 6 | 0.6 | 7.3 | 18.5 |
| Example 83 | Co₈₀Pt₂₀-30 vol % La₂O₃ | 7 | 0.6 | 7.1 | 16.0 |
| Example 84 | Co₈₀Pt₂₀-30 vol % La₂O₃ | 8 | 0.6 | 6.3 | 13.5 |
| Example 85 | Co₈₀Pt₂₀-30 vol % La₂O₃ | 9 | 0.6 | 5.3 | 12.0 |

TABLE 3

| | Composition of | Thickness | Ar gas | Hc | Hs |
|---|---|---|---|---|---|
| | cap layer | (nm) | pressure (Pa) | (kOe) | (kOe) |
| Example 86 | Co₈₀Pt₂₀-30 vol % Pr₆O₁₁ | 1 | 0.6 | 8.2 | 19.0 |
| Example 87 | Co₈₀Pt₂₀-30 vol % Pr₆O₁₁ | 2 | 0.6 | 8.1 | 19.0 |
| Example 88 | Co₈₀Pt₂₀-30 vol % Pr₆O₁₁ | 3 | 0.6 | 8.0 | 19.0 |
| Example 89 | Co₈₀Pt₂₀-30 vol % Pr₆O₁₁ | 4 | 0.6 | 7.9 | 18.5 |
| Example 90 | Co₈₀Pt₂₀-30 vol % Pr₆O₁₁ | 5 | 0.6 | 7.7 | 17.5 |
| Example 91 | Co₈₀Pt₂₀-30 vol % Pr₆O₁₁ | 6 | 0.6 | 7.5 | 17.0 |
| Example 92 | Co₈₀Pt₂₀-30 vol % Pr₆O₁₁ | 7 | 0.6 | 7.3 | 16.5 |
| Example 93 | Co₈₀Pt₂₀-30 vol % Pr₆O₁₁ | 8 | 0.6 | 7.1 | 15.0 |
| Example 94 | Co₈₀Pt₂₀-30 vol % Pr₆O₁₁ | 9 | 0.6 | 6.7 | 13.5 |
| Example 95 | Co₈₀Pt₂₀-30 vol % Ho₂O₃ | 1 | 0.6 | 7.9 | 19.0 |
| Example 96 | Co₈₀Pt₂₀-30 vol % Ho₂O₃ | 2 | 0.6 | 7.8 | 18.5 |
| Example 97 | Co₈₀Pt₂₀-30 vol % Ho₂O₃ | 3 | 0.6 | 7.7 | 18.5 |
| Example 98 | Co₈₀Pt₂₀-30 vol % Ho₂O₃ | 4 | 0.6 | 7.7 | 18.0 |
| Example 99 | Co₈₀Pt₂₀-30 vol % Ho₂O₃ | 5 | 0.6 | 7.6 | 17.5 |
| Example 100 | Co₈₀Pt₂₀-30 vol % Ho₂O₃ | 6 | 0.6 | 7.2 | 17.0 |
| Example 101 | Co₈₀Pt₂₀-30 vol % Ho₂O₃ | 7 | 0.6 | 6.9 | 16.5 |
| Example 102 | Co₈₀Pt₂₀-30 vol % Ho₂O₃ | 8 | 0.6 | 6.5 | 16.0 |
| Example 103 | Co₈₀Pt₂₀-30 vol % Ho₂O₃ | 9 | 0.6 | 6.0 | 14.5 |
| Example 104 | Co₈₀Pt₂₀-30 vol % Er₂O₃ | 1 | 0.6 | 8.3 | 19.0 |
| Example 105 | Co₈₀Pt₂₀-30 vol % Er₂O₃ | 2 | 0.6 | 8.1 | 18.7 |
| Example 106 | Co₈₀Pt₂₀-30 vol % Er₂O₃ | 3 | 0.6 | 7.8 | 18.5 |
| Example 107 | Co₈₀Pt₂₀-30 vol % Er₂O₃ | 4 | 0.6 | 7.7 | 18.0 |
| Example 108 | Co₈₀Pt₂₀-30 vol % Er₂O₃ | 5 | 0.6 | 7.6 | 18.0 |
| Example 109 | Co₈₀Pt₂₀-30 vol % Er₂O₃ | 6 | 0.6 | 7.3 | 17.5 |
| Example 110 | Co₈₀Pt₂₀-30 vol % Er₂O₃ | 7 | 0.6 | 7.0 | 17.0 |
| Example 111 | Co₈₀Pt₂₀-30 vol % Er₂O₃ | 8 | 0.6 | 6.7 | 16.5 |
| Example 112 | Co₈₀Pt₂₀-30 vol % Er₂O₃ | 9 | 0.6 | 6.5 | 15.0 |
| Example 113 | Co₈₀Pt₂₀-30 vol % Yb₂O₃ | 1 | 0.6 | 8.0 | 19.0 |
| Example 114 | Co₈₀Pt₂₀-30 vol % Yb₂O₃ | 2 | 0.6 | 7.8 | 18.5 |
| Example 115 | Co₈₀Pt₂₀-30 vol % Yb₂O₃ | 3 | 0.6 | 7.7 | 18.0 |
| Example 116 | Co₈₀Pt₂₀-30 vol % Yb₂O₃ | 4 | 0.6 | 7.6 | 18.0 |
| Example 117 | Co₈₀Pt₂₀-30 vol % Yb₂O₃ | 5 | 0.6 | 7.6 | 17.5 |
| Example 118 | Co₈₀Pt₂₀-30 vol % Yb₂O₃ | 6 | 0.6 | 7.2 | 17.0 |
| Example 119 | Co₈₀Pt₂₀-30 vol % Yb₂O₃ | 7 | 0.6 | 7.0 | 16.5 |
| Example 120 | Co₈₀Pt₂₀-30 vol % Yb₂O₃ | 8 | 0.6 | 6.5 | 16.0 |
| Example 121 | Co₈₀Pt₂₀-30 vol % Yb₂O₃ | 9 | 0.6 | 6.0 | 14.0 |

TABLE 4

| | Composition of | Thickness | Ar gas | Hc | Hs |
|---|---|---|---|---|---|
| | cap layer | (nm) | pressure (Pa) | (kOe) | (kOe) |
| Example 122 | Co₈₀Pt₂₀-5 vol % Gd₂O₃ | 5 | 0.6 | 5.0 | 11.0 |
| Example 123 | Co₈₀Pt₂₀-10 vol % Gd₂O₃ | 5 | 0.6 | 5.3 | 12.5 |
| Example 124 | Co₈₀Pt₂₀-15 vol % Gd₂O₃ | 5 | 0.6 | 5.8 | 13.5 |
| Example 125 | Co₈₀Pt₂₀-20 vol % Gd₂O₃ | 5 | 0.6 | 6.2 | 14.5 |
| Example 126 | Co₈₀Pt₂₀-25 vol % Gd₂O₃ | 5 | 0.6 | 6.5 | 16.0 |
| Example 127 | Co₈₀Pt₂₀-35 vol % Gd₂O₃ | 5 | 0.6 | 7.5 | 18.0 |
| Example 128 | Co₈₀Pt₂₀-40 vol % Gd₂O₃ | 5 | 0.6 | 7.9 | 19.0 |
| Example 129 | Co₉₀Pt₁₀-30 vol % Gd₂O₃ | 5 | 0.6 | 5.0 | 13.5 |
| Example 130 | Co₈₅Pt₁₅-30 vol % Gd₂O₃ | 5 | 0.6 | 6.0 | 15.0 |
| Example 131 | Co₇₅Pt₂₅-30 vol % Gd₂O₃ | 5 | 0.6 | 7.5 | 18.0 |
| Example 132 | Co₇₀Pt₃₀-30 vol % Gd₂O₃ | 5 | 0.6 | 7.7 | 18.5 |
| Example 133 | Co₆₅Pt₃₅-30 vol % Gd₂O₃ | 5 | 0.6 | 6.0 | 15.5 |
| Example 134 | Co₇₅Pt₂₀Cr₅-30 vol % Gd₂O₃ | 5 | 0.6 | 6.0 | 16.0 |
| Example 135 | Co₇₀Pt₂₀Cr₁₀-30 vol % Gd₂O₃ | 5 | 0.6 | 5.0 | 15.0 |
| Example 136 | Co₇₅Pt₂₀Ru₅-30 vol % Gd₂O₃ | 5 | 0.6 | 6.1 | 16.5 |
| Example 137 | Co₇₅Pt₂₀B₅-30 vol % Gd₂O₃ | 5 | 0.6 | 6.5 | 16.8 |
| Example 138 | Co₇₅Pt₂₀Ta₅-30 vol % Gd₂O₃ | 5 | 0.6 | 6.4 | 16.5 |
| Example 139 | Co₇₅Pt₂₀Nb₅-30 vol % Gd₂O₃ | 5 | 0.6 | 6.2 | 16.0 |
| Example 140 | Co₇₅Pt₂₀W₅-30 vol % Gd₂O₃ | 5 | 0.6 | 6.0 | 16.0 |
| Example 141 | Co₇₅Pt₂₀Ti₅-30 vol % Gd₂O₃ | 5 | 0.6 | 6.3 | 16.0 |
| Example 142 | Co₇₅Pt₂₀Mo₅-30 vol % Gd₂O₃ | 5 | 0.6 | 6.1 | 16.0 |

As can be seen from Tables 1-4, Examples 1-142, which are included within the scope of the present invention, all have a coercive force Hc of 5 kOe or more and a saturation magnetic field Hs of less than 20 kOe. In contrust, for Comparative Examples 1 to 20, which are not within the scope of the present invention, the coercive force Hc is less than 5 kOe or the saturation magnetic field Hs is 20 kOe or more.

If the coercive force Hc is less than 5 kOe, for any of them, the thermal stability is insufficient, and if the saturation magnetic field Hs is 20 kOe or more, the switching magnetic field is too large, and the ease of magnetic recording is in sufficient.

### Examples 143-159, Comparative Example 21

In Examples 143-159 and Comparative Example 21, samples were produced by changing the composition of the cap layer, and the thermal stability of the cap layer was evaluated by measuring the activated grain diameter GD_{act} of the cap layer. In the samples of Examples 143-159 and Comparative Example 21, the perpendicular magnetic recording layer 24 was not provided, and the cap layer 26 with a thickness of 16 nm was provided on top of the buffer layer 22. Other than that, the samples were produced in the same manner as in Examples 1 to 142. The deposition conditions for providing the cap layer 26 with a thickness of 16 nm on top of the buffer layer 22 were an argon gas pressure of 4.0 Pa and supplying power of 500 W.

For each sample of Examples 143-159 and Comparative Example 21, the activated grain diameter GD_{act} was measured using a magnet o optical Kerr effect (MOKE) measurement apparatus.

The following Table 5 shows the measured activated grain diameter GD_{act}. B₂O₃ used in Comparative Example 21 is the oxide used in Comparative Examples 2-14, Gd₂O₃ used in Examples 143, 153-159 is the oxide used in Examples 1-17, 122-142, and Comparative Examples 15-19, Nd₂O₃ used in Example 144 is the oxide used in Examples 18-34, Sm₂O₃ used in Example 145 is the oxide used in Examples 35-51, CeO₂ used in Example 146 is the oxide used in Examples 52-67, Eu₂O₃ used in Example 147 is the oxide used in Examples 68-76, La₂O₃ used in Example 148 is the oxide used in Examples 77-85, Pr₆O₁₁ used in Example 149 is the oxide used in Examples 86-94, Ho₂O₃ used in Example 150 is the oxide used in Examples 95-103, Er₂O₃ used in Example 151 is the oxide used in Examples 104-112, and Yb₂O₃ used in Example 152 is the oxide used in Examples 113-121.

Examples 143, 153-159 are examples in which the volume fraction of Gd₂O₃ was changed in the range of 5-40 vol %.

TABLE 5

| | Composition of | |
|---|---|---|
| | cap layer | G_{act} (nm) |
| Comparative Example 21 | Co₈₀Pt₂₀-30 vol % B₂O₃ | 6.5 |
| Example 143 | Co₈₀Pt₂₀-30 vol % Gd₂O₃ | 10.1 |
| Example 144 | Co₈₀Pt₂₀-30 vol % Nd₂O₃ | 8.8 |
| Example 145 | Co₈₀Pt₂₀-30 vol % Sm₂O₃ | 8.7 |
| Example 146 | Co₈₀Pt₂₀-30 vol % CeO₂ | 9.5 |
| Example 147 | Co₈₀Pt₂₀-30 vol % Eu₂O₃ | 8.9 |
| Example 148 | Co₈₀Pt₂₀-30 vol % La₂O₃ | 10.5 |
| Example 149 | Co₈₀Pt₂₀-30 vol % Pr₆O₁₁ | 9.1 |
| Example 150 | Co₈₀Pt₂₀-30 vol % Ho₂O₃ | 8.5 |
| Example 151 | Co₈₀Pt₂₀-30 vol % Er₂O₃ | 9.0 |
| Example 152 | Co₈₀Pt₂₀-30 vol % Yb₂O₃ | 8.6 |
| Example 153 | Co₈₀Pt₂₀-5 vol % Gd₂O₃ | 21.6 |
| Example 154 | Co₈₀Pt₂₀-10 vol % Gd₂O₃ | 19.3 |
| Example 155 | Co₈₀Pt₂₀-15 vol % Gd₂O₃ | 17.5 |
| Example 156 | Co₈₀Pt₂₀-20 vol % Gd₂O₃ | 14.7 |
| Example 157 | Co₈₀Pt₂₀-25 vol % Gd₂O₃ | 12.1 |
| Example 158 | Co₈₀Pt₂₀-35 vol % Gd₂O₃ | 8.6 |
| Example 159 | Co₈₀Pt₂₀-40 vol % Gd₂O₃ | 7.3 |

Among the oxides listed in Table 5, the non-magnetic oxide is only B₂O₃ in Comparative Example 21, while the oxides in Examples 143-159 (Gd₂O₃, Nd₂O₃, Sm₂O₃, CeO₂, Eu₂O₃, La₂O₃, Pr₆O₁₁, Ho₂O₃, Er₂O₃, and Yb₂O₃) are magnetic oxides.

As is clear from Table 5, when the volume fraction of the oxide in the cap layer is 30 vol %, the activated grain diameter GD_{act} of the cap layer whose oxide is B₂O₃, which is a non-magnetic oxide, is 6.5 nm, whereas the activated grain diameter GD_{act} of the cap layer whose oxide is magnetic oxide (Gd₂O₃, Nd₂O₃, Sm₂O₃, CeO₂, Eu₂O₃, La₂O₃, Pr₆O₁₁, Ho₂O₃, Er₂O₃, Yb₂O₃) is 8.5 t o 10.5 nm, which is 30% or more larger than the activated grain diameter GD_{act} of the cap layer whose oxide is B₂O₃, which is a non-magnetic oxide. This suggests that the cap layer whose oxide is magnetic oxide (Gd₂O₃, Nd₂O₃, Sm₂O₃, CeO₂, Eu₂O₃, La₂O₃, Pr₆O₁₁, Ho₂O₃, Er₂O₃, Yb₂O₃) has excellent thermal stability.

In addition, as is clear from Examples 143, 153-159, when the volume fraction of Gd₂O₃ in the cap layer is changed in the range of 5-40 vol %, the smaller the volume fraction of Gd₂O₃ is, the larger the value of the activated grain diameter GD_{act} is, which is considered to be superior in thermal stability.

### Cross-Sectional TEM Photograph

FIG. 5 is a cross-sectional TEM photograph of a region containing a cap layer (Co₈₀Pt₂₀- 30 vol % Gd₂O₃) (deposited at an argon gas pressure of 0.6 Pa) with a thickness of 9 nm in Example 17, FIG. 6 is a cross-sectional TEM photograph of a region containing a cap layer (Co₈₀Pt₂₀- 30 vol % Gd₂O₃) (deposited at an argon gas pressure of 4.0 Pa) with a thickness of 9 nm in Example 8, and FIG. 7 is a cross-sectional TEM photograph of a region containing a cap layer (CoPtCrB) in a current perpendicular magnetic recording medium (Comparative Example 20).

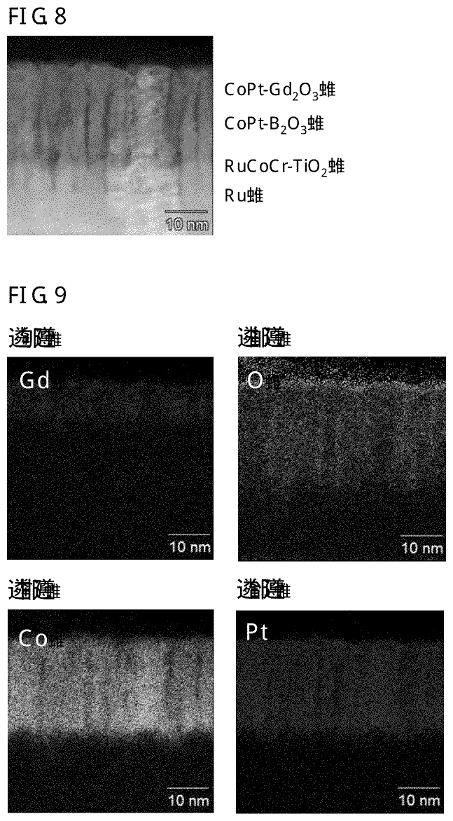

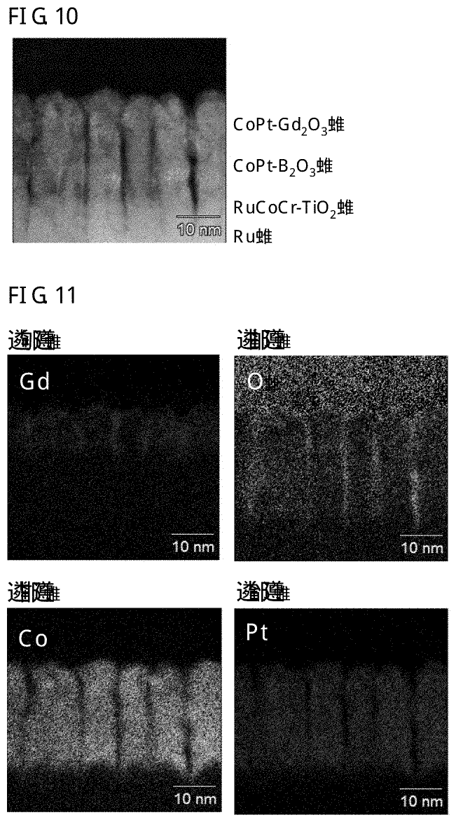

FIG. 8 is a dark field image of a portion of the cross-sectional region of Example 17 shown in FIG. 5, taken by a scanning transmission electron microscope (STEM), and FIG. 9 is photographs showing the measurement results of energy dispersive X-ray analysis (EDX) performed by a scanning transmission electron microscope (STEM) for a portion of the cross-sectional region of Example 17 shown in FIG. 5. FIG. 10 is a dark field image of a portion of the cross-sectional region of Example 8 shown in FIG. 6, taken by a scanning transmission electron microscope (STEM), and FIG. 11 is photographs showing the measurement results of energy dispersive X-ray analysis (EDX) performed by a scanning transmission electron microscope (STEM) for a portion of the cross-sectional region of Example 8 shown in FIG. 6. FIG. 12 is a dark-field image of a portion of the cross-sectional region of the current perpendicular magnetic recording medium (Comparative Example 20) shown in FIG. 7, taken by a scanning transmission electron microscope (STEM), and FIG. 13 is photographs showing the measurement results of energy dispersive X-ray analysis (EDX) performed by a scanning transmission electron microscope (STEM) for a portion of the cross-sectional region of the current perpendicular magnetic recording medium (Comparative Example 20) shown in FIG. 7.

As can be read from FIGS. 5, 6, and 8 to 11, in both Example 17, in which the cap layer was deposited to a thickness of 9 nm at an argon gas pressure of 0.6 Pa, and Example 8, in which the cap layer was deposited to a thickness of 9 nm at an argon gas pressure of 4.0 Pa, no voids are created on the non-magnetic grain boundary oxide 24B (B₂O₃) of the perpendicular magnetic recording layer 24. In addition, the boundary between the perpendicular magnetic recording layer (CoPt-B₂O₃ layer) and the cap layer (Co₈₀Pt₂₀- 30 vol % Gd₂O₃) is flat.

In contrast, as can be read from FIG. 7, FIG. 12, and FIG. 13, in the current perpendicular magnetic recording media (Comparative Example 20), the boundary surface between the perpendicular magnetic recording layer (CoPt-B₂O₃ layer) and the cap layer (CoPtCrB layer) is wavy and the unevenness of the surface is large.

The shape of the CoPt alloy magnetic grains in the perpendicular magnetic recording layer (CoPt-B₂O₃ layer) can be inferred from the distribution state of Co and Pt shown in FIGS. 9, 11, and 13.

In addition, as apparent from FIGS. 5 and 6, the surface of the cap layer (Co₈₀Pt₂₀- 30 vol % Gd₂O₃) of Example 17 deposited to a thickness of 9 nm at an argon gas pressure of 0.6 Pa is flatter than that of the cap layer (Co₈₀Pt₂₀- 30 vol % Gd₂O₃) of Example 8 deposited to a thickness of 9 nm at an argon gas pressure of 4.0 Pa, indicating that the cap layer of Example 17 deposited at an argon gas pressure of 0.6 Pa is better.

### Planar TEM Photograph

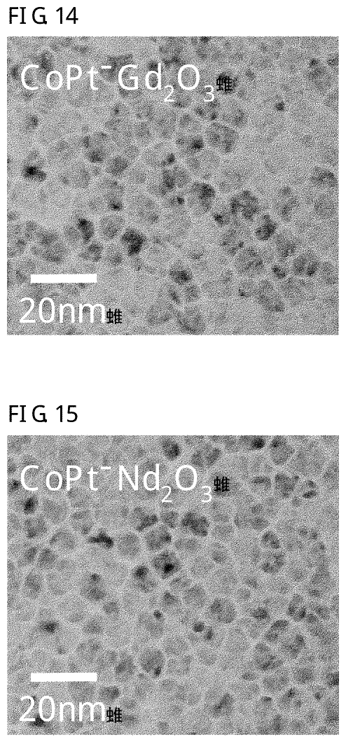

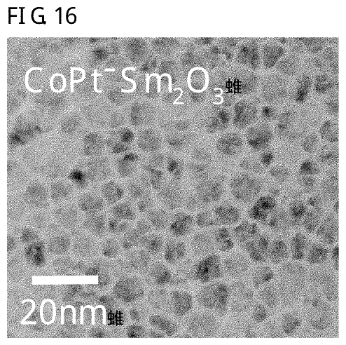

FIG. 14 is a planar TEM photograph of the horizontal cross section of the region containing the cap layer (Co₈₀Pt₂₀- 30 vol % Gd₂O₃) of Example 143, and FIG. 15 is a planar TEM photograph of the horizontal cross section of the region containing the cap layer (Co₈₀Pt₂₀- 30 vol % Nd₂O₃) of Example 144, and FIG. 16 is a planar TEM photograph of the horizontal cross section of the region containing the cap layer (Co₈₀Pt₂₀- 30 vol % Sm₂O₃) of Example 145.

As shown in FIGS. 14-16, it was confirmed that the cap layer of Examples 143-145 has a granular structure.

### INDUSTRIAL APPLICABILITY

The perpendicular Magnetic recording media according to the present invention has a cap layer with better characteristics (characteristics to improve the thermal stability of the perpendicular magnetic recording media and to reduce the switching magnetic field) than the current cap layer, and the thermal stability is improved and the switching magnetic field is reduced. Therefore, the perpendicular magnetic recording media according to the present invention has an industrial applicability.

### REFERENCE SIGNS LIST

10 perpendicular magnetic recording medium
12 substrate
14 adhesion layer
16 seed layer
18 first Ru underlayer
20 second Ru underlayer
22 buffer layer
24 perpendicular magnetic recording layer
24A, 26A CoPt alloy magnetic grain
24B non-magnetic grain boundary oxide
26 cap layer
26B magnetic grain boundary oxide
26C intergranular exchange coupling
28 surface protection layer

1. A perpendicular magnetic recording medium comprising a perpendicular magnetic recording layer and a cap layer covering the perpendicular magnetic recording layer, wherein
the perpendicular magnetic recording layer contains a granular structure having CoPt alloy magnetic crystal grains and a non-magnetic grain boundary oxide;
the cap layer contains a granular structure having CoPt alloy magnetic crystal grains and a magnetic grain boundary oxide;
the CoPt alloy magnetic crystal grains in the cap layer contain Co in a range of 65 at % or more and 90 at % or less and Pt in a range of 10 at % or more and 35 at % or less; and
the volume fraction of the magnetic grain boundary oxide to the entire cap layer is 5 vol % or more and 40 vol % or less.

2. A perpendicular magnetic recording medium comprising a perpendicular magnetic recording layer and a cap layer covering the perpendicular magnetic recording layer, wherein
the perpendicular magnetic recording layer contains a granular structure having CoPt alloy magnetic crystal grains and a non-magnetic grain boundary oxide;
the cap layer contains a granular structure having CoPt alloy magnetic crystal grains and a magnetic grain boundary oxide;
the CoPt alloy magnetic crystal grains in the cap layer contain Co in a range of 70 at % or more and less than 85 at %, Pt in a range of 10 at % or more and 20 at % or less, and at least one element selected from the group consisting of Cr, Ti, B, Mo, Ta, Nb, W and Ru in a range of 0.5 at % or more and 15 at % or less; and
the volume fraction of the magnetic grain boundary oxide to the entire cap layer is 5 vol % or more and 40 vol % or less.

3. The perpendicular magnetic recording medium according to claim 1, wherein the magnetic grain boundary oxide is a rare earth oxide.

4. The perpendicular magnetic recording medium according to claim 1, wherein the magnetic grain boundary oxide is at least one oxide of a Gd oxide, a Nd oxide, a Sm oxide, a Ce oxide, an Eu oxide, a La oxide, a Pr oxide, a Ho oxide, an Er oxide, a Yb oxide, and a Tb oxide.

5. The perpendicular magnetic recording medium according to claim 2, wherein the magnetic grain boundary oxide is a rare earth oxide.

6. The perpendicular magnetic recording medium according to claim 2, wherein the magnetic grain boundary oxide is at least one oxide of a Gd oxide, a Nd oxide, a Sm oxide, a Ce oxide, an Eu oxide, a La oxide, a Pr oxide, a Ho oxide, an Er oxide, a Yb oxide, and a Tb oxide.
